(19) United States
(12) Patent Application Publication
(10) Pub. No.: US 2025/0379309 A1
(43) Pub. Date: Dec. 11, 2025

(54) HOT FORMED BATTERY TRAY WITH SOFT CORNER REGIONS

(71) Applicant: BENTELER AUTOMOBILTECHNIK GMBH, Paderborn (DE)

(72) Inventors: Christian BUSE, Lichtenau (DE); Christian HANDING, Langenberg (DE); Ruediger ERHARDT, Paderborn (DE); Georg FROST, Steinheim (DE)

(21) Appl. No.: 19/234,195

(22) Filed: Jun. 10, 2025

(30) Foreign Application Priority Data
Jun. 11, 2024 (EP) 24181404.5

(51) Int. Cl. H01M 50/224; H01M 50/231; H01M 50/236; H01M 50/24; H01M 50/242; H01M 50/249

(52) U.S. Cl. CPC H01M 50/224; H01M 50/231; H01M 50/236; H01M 50/24; H01M 50/242; H01M 50/249

(57) ABSTRACT

A battery tray for a battery support of an electric vehicle, and the battery tray has a base and a one-piece and material-uniform peripheral wall extending from the base and optionally an outer peripheral flange projecting from the wall. The battery tray is made of a hardenable sheet steel blank as a hot-formed and press-hardened component.

### RELATED APPLICATIONS

The present application claims priority of European Application Number 24181404.5 filed Jun. 11, 2024, the disclosure of which is hereby incorporated by reference herein in its entirety.

### FIELD The present disclosure relates to a battery tray for a battery support of an electric vehicle.

### BACKGROUND

Electromobility refers to electric vehicles, which are driven by electric motors. The energy required therefor is carried along in a corresponding battery storage. Such battery storages are also called battery supports or battery trays. These have a battery tray, which is optionally closed by a lid. The drive batteries or batteries are then accommodated in the interior of the tray-shaped housing. Such a battery support is generally arranged in the underfloor region of an electric vehicle.

The battery supports are able to be made of a metallic material, for example, a steel or aluminum material. The batteries in the interior of the battery support are to be protected from environmental influences, like weather conditions and moisture. At the same time, in the event of a crash, the interior of the battery support should be designed to be fluid-tight, so that any liquids, like coolants or liquids in the battery, do not get into the environment.

The battery supports are able to be made of a metallic material, such as a steel but also an aluminum material. In the case of steel material, the battery trays are referred to as forming components. For this purpose, the battery tray is formed by means of a forming process, like a deep-drawing process.

Such battery trays are able to be produced as hot-formed and press-hardened components. In this case, tensile strengths Rm of more than 1000 MPa are able to be achieved with the aid of hot-forming press hardening technology.

### SUMMARY

The present disclosure relates to a battery tray for a battery support which is produced by forming, but which is at the same time optimized with respect to its geometrical dimension, for example, with respect to the capacity for receiving batteries arranged in the interior.

The above-mentioned object is achieved according to the present disclosure with a battery tray for a battery support of an electric vehicle.

The battery tray for a battery support of an electric vehicle has a base. The base is flat. However, the base is able to have optional reinforcing structures in order to provide, for example, a stiffening, an underride protection and/or a cooling base.

A peripheral wall extending from the base is formed in one piece and in the same material. The peripheral wall thus has, relative to the transverse direction of the motor vehicle, two outer side walls. The peripheral wall also has a front wall on the front side and a rear wall on the rear side in the longitudinal direction of the motor vehicle. In plan view, the battery tray has, for example, an region greater than 2 m². The side wall has a height greater than 10 cm, greater than 12 cm, greater than 15 cm, and greater than 18 cm.

Optionally, a flange projecting outwards from the peripheral wall is also formed. The flange is likewise designed to be peripheral. The flange is able to be a bearing surface and at the same time as a bearing and sealing surface for a cover. The cover is able to be flat. The cover is also able to be placed like a hood.

The battery tray is also made of a single sheet steel blank. The sheet steel blank is made of a hardenable steel alloy. For example, a boron-manganese steel is able to be used, for example, 22MnB5. The battery tray is also produced by hot forming and press hardening and thus has a tensile strength Rm≥1250 MPa.

According to the present disclosure, the battery tray is able to have a tensile strength Rm which is less than 1000 MPa in a respective corner region of the side walls with respect to one another. A corner region is the region where the respective side walls are arranged. Referred to the transverse direction of the motor vehicle, for example, the outer side wall with the rear wall or with the front wall form the corner region. This corner region is also constructed in one piece and in a uniform material, since the entire battery tray is produced by a corresponding forming process, for example, a deep-drawing process. The deformation process is thus able to be optimized by virtue of the fact that a material structure with lower strength is formed in the corner region. A targeted material flow from the base, from the remaining region of the wall or the side walls and/or a material flow from the flange is achieved, so that there is no crack formation or excessively high stretching in the corner region. The corner region is able to thus be shaped more optimally or sharply. In at least one embodiment of the present disclosure, the battery tray is produced by the method described below, so that the product properties mentioned are also established in this case.

According to the present disclosure, the corner region lies between two adjacent side walls. However, the corner region is also able to include at least part of the transition from the base in the respective corner region of the side walls, the transition being formed as a deep-drawing radius.

In at least one embodiment of the present disclosure, in the case of a battery tray which is quadrangular in plan view, each corner is designed with a tensile strength Rm<1000 MPa.

In at least one embodiment of the present disclosure, is a soft corner region in which two side walls are arranged at an angle of from 80° to 110° and from 90° to 110°, from 90° to 100°, to one another.

If a battery tray has, for example, more than 4 corners, is hexagonal, for example, in plan view, and corners or corner regions are formed to be greater than 90°, for example, 2 corner regions at 90°, these 90° corner regions between two side walls in plan view have, according to the present disclosure, a tensile strength Rm <1,000 MPa. If 4 further corner regions of approximately 135° each are formed, these 135° corner regions in plan view is able to be completely hardened.

In the case of a battery tray which is rectangular in plan view and consequently has four corner regions, each corner region is of soft design, as described above. In the case of a polygonal battery tray, at least two corner regions are able to be soft.

If a flange is provided, the corner region of the flange is able to likewise have the relatively softer material structure with a tensile strength Rm of less than 1100 MPa. According to the present disclosure, however, the outer flange region also has the relatively higher strength in the corner region with a tensile strength Rm of greater than 1250 MPa. In at least one embodiment of the present disclosure, with regard to a possible crash safety or stiffening of the battery tray, an optimum is able to be achieved in this way.

In at least one embodiment of the present disclosure, the relatively softer tensile strength is formed in the corner region between 550 and 800 MPa, which is achieved by targeted adjustment of a mixed structure or intermediate-stage structure. In the corner region, this is a mixed structure of bainite and/or ferrite and/or perlite with corresponding proportions of martensite and, if appropriate, residual austenite.

A martensitic structure is then formed in the remaining region of the battery tray, for example, in the base and the side walls and in the flange. This has a tensile strength Rm of greater than 1250 MPa, greater than 1350 MPa, and greater than 1500 MPa.

Due to the very high tensile strength Rm in the region of the entire battery tray, a thin-walled material is able to be used. High strength properties, thus high rigidity, but also high crash safety and high load-bearing capacity for the batteries arranged in the interior, which are able to weigh several hundred kilograms, are achieved. Due to the small wall thickness, less than 5 mm, less than 3 mm, or in between 1 mm and 2 mm, the battery tray has a low dead weight.

In at least one embodiment of the present disclosure, the battery tray is able to be used for inserting or laying drive batteries. However, the battery tray is also able to be pulled over the batteries as a hood from above in order to form a closed battery support with a base plate or a further battery tray.

As a result of the further approach according to the present disclosure, for example, during production, in the deep-drawing process with soft corner regions, a small wall thickness is able to be used in the starting material of the blank, since only small stretches and/or small crack formation are able to be expected. Thus, the wall thickness is able to be minimized due to the forming of the corner regions.

Furthermore, the tensile strength Rm is likewise greater than 1250 MPa in the transitions from base to side wall. These transitions extend over at least 70% of the length of a respective side wall. In at least one embodiment of the present disclosure, this again results in a high crash safety in the event of a side crash, but also in the event of a frontal crash, since a correspondingly high tensile strength is achieved via the parts of the transition which are for the crash scenarios mentioned, which in turn gives the battery tray sufficient inherent rigidity.

Furthermore, a hollow profile, for example an L-shaped hollow profile or also a hat profile, is able to be coupled on the outside to the side wall and/or to the flange. This hat profile is able to be coupled from the outside to the side wall, for example, by means of a joining process, by means of spot welding. Possible softenings are to be neglected. The hollow profile or a corresponding side reinforcement itself is not the vehicle sill or a longitudinal vehicle frame support. The hollow profile is an integral part of the battery support itself. This thus offers an improvement in the side impact protection as well as a possibility of a vehicle body fastening, and consequently the battery support is able to be fastened to a vehicle body via the hollow profile. For example, the battery support is able to be coupled from below to a vehicle sill or a longitudinal vehicle frame support, for example, screwed on.

Furthermore, the blank has an anti-corrosion coating, and this is, for example, a coating based on aluminum-silicon.

Another possibility according to the present disclosure provides for the side walls to have a different height from one another on the front and rear sides and on the respective outer sides. A corresponding cover, which is coupled to the battery tray, is then adapted in a complementary manner to the different heights of the side walls.

Furthermore, longitudinal and/or transverse beads are then able to be formed in the base in one piece and in the same material. A corresponding cooling channel structure is also able to be molded in or stamped into the base. Thus, a stiffening of the base is formed which is able to serve as underride protection or as bollard protection. A corresponding cooling channel structure or a corresponding spacer is also able to be stamped into the base. These are then designed to point downwards in the vertical direction of the motor vehicle in the installed state. A cooling channel structure is then able to be formed with a further base plate or inner plate, so that batteries arranged in the battery tray or batteries standing on the base are able to be correspondingly cooled.

In at least one embodiment of the present disclosure, the corner region is not additionally displaced outwards with respect to the interior. Thus, the corner region lies behind an extension of the side wall or the transverse wall. In at least one embodiment of the present disclosure, in the case of reinforcing profiles arranged on the outside, these are thus able to extend into the corner region. If the corner region were again displaced or adjusted outwards, a continuous connection to a longitudinal profile would not be possible here.

The present disclosure further includes a corresponding method for the production of the previously described battery tray with the following steps:
providing a blank made of a hardenable steel alloy,
partial austenitizing or complete austenitizing and partial intermediate cooling of the later corner regions,
inserting into a hot forming and press hardening tool, and hot forming and press hardening, wherein a tensile strength Rm of greater than or equal to 1250 MPa is set in the battery tray and a tensile strength of less than 1100 MPa is set in the corner regions.

Austenitization is to be understood as meaning heating to above Ac3 temperature, that is to say, depending on the hardenable steel alloy used, at a temperature of greater than 900° C.

In the method according to the present disclosure, a blank made of a hardenable steel alloy is able to be initially austenitized, and thus to generate a temperature above Ac3 in the regions in which the later base and the side walls are formed. However, complete austenitization is able to take place, in the case of a coated blank, so that the precoating passes through in the alloy.

After complete austenitization, the later corner regions are targetedly cooled or intercooled. This is able to be effected, for example, by blowing on by means of nozzles. Contact cooling is also able to take place. In this case, an intermediate-stage structure is also able to be formed. In at least one embodiment of the present disclosure, the temperature is cooled by a temperature of 70° C. to 200° C., 100° C. to 150° C., compared to the Ac3 temperature, so these regions have a temperature between 600° C. and 800° C. As a result, these regions are less soft, so that a targeted flow of material from the warmer and thus softer adjacent base, side wall regions and/or the flange into the corner region takes place and, as a result, critical stretches are selectively avoided in the corner region itself during the deformation. This results in a negligible thinning of the material in the corner region to be formed. Crack formation is also avoided. The starting blank is thus able to have an optimized, for example, smaller, wall thickness without any tearing or excessive thinning in the corner region during the subsequent hot forming process. The steel sheet blank thus partially tempered is inserted into a hot-forming tool or partially cooled in the hot-forming tool described above. Subsequently, the hot forming process takes place as well as by a corresponding quenching hardening or press hardening, the hardening and a conversion into a hardened material structure. From the previously austenitic range, this is then a martensitic hard material structure. In the intermediate cooled regions, a mixed structure of perlite, ferrite and/or bainite is established in conjunction with martensitic fractions and the remainder of the austenite fractions. The corner regions then remain relatively soft even in the finished component. Due to the higher degree of deformation in the corner regions, a stretching has also taken place here. The fact that the region is on the one hand intermediately cooled and is thus more easily deformable, but also has a softer tensile strength in the later finished component, reliably prevents delayed crack formation (delayed fracturing) during further production and assembly steps on the one hand and in the event of a vehicle crash on the other hand.

### BRIEF DESCRIPTION OF THE DRAWINGS

Further advantages, features, properties, and aspects of the present disclosure are the subject of the following description. Various embodiments are shown in the schematic figures. These simplify the understanding of the present disclosure. The embodiments previously and successively described are able to be combined individually with each other as desired without departing from the scope of the present disclosure. In the figures:

FIG. 1 is a perspective view of a battery tray produced according to at least one embodiment of the present disclosure with a soft corner region,

FIG. 2A and FIG. 2B show a blank and a later formed battery tray in plan view according to at least one embodiment of the present disclosure,

FIG. 3A and FIG. 3B show a blank and a battery tray formed later in plan view according to at least one embodiment of the present disclosure with soft flange region,

FIG. 4 shows a cross-section through a corner region according to section line IV-IV of FIG. 2A and FIG. 2B according to at least one embodiment of the present disclosure,

FIG. 5 shows a cross-section along section line V-V in FIG. 2A and FIG. 2B according to at least one embodiment of the present disclosure,

FIG. 6 shows in plan view a hexagonal battery tray according to at least one embodiment of the present disclosure, and

FIG. 7 shows a plan view according to at least one embodiment of the present disclosure of a hexagonal battery tray.

### DETAILED DESCRIPTION

In the figures, the same reference numerals are used for same or similar components, although a repeated description or illustration is omitted for reasons of simplicity.

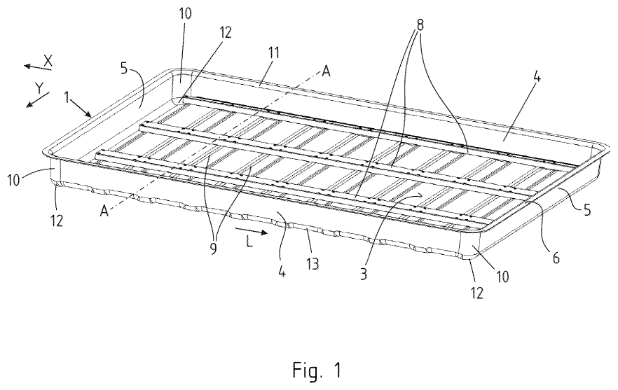

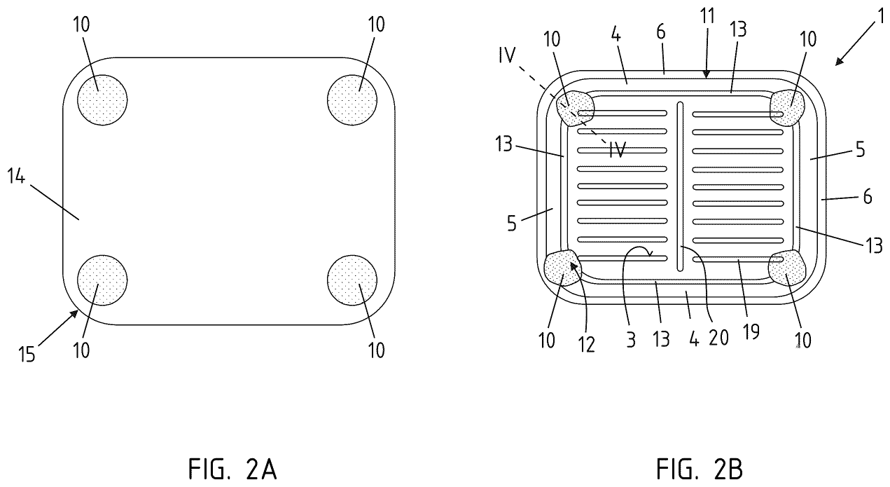

FIG. 1 shows a deep-drawn tray 1 produced according to the present disclosure for a battery support 2 shown in FIG. 2A and FIG. 2B. The battery support 2 has the tray itself, the tray 1 having a base 3 and a wall 4, 5 which runs around at an angle α to the base 3. The walls are also referred to below as longitudinal wall 4 and transverse wall 5. Furthermore, a respective flange 6 is arranged laterally projecting from the walls. The flange 6 is able to be used as a drawing flange during deep drawing and subsequently for coupling to a cover 7 shown. Longitudinal struts 8 are able to be arranged in the tray 1 itself. The longitudinal struts 8 are suitable for the arrangement and fastening of batteries, not shown in detail, in the tray 1. Furthermore, as shown in FIG. 1, transverse beads 9 are able to be formed in the base 3 of the tray 1.

According to at least one embodiment of the present disclosure, a respective corner region 10 has a lower tensile strength in contrast to the side walls 4, 5 which are formed from the respective longitudinal walls 4 or transverse walls 5. An externally peripheral flange 6 projects in each case from the side walls, i.e., the transverse walls 5 and the longitudinal walls 4. The flange 6, the longitudinal walls 4, the transverse walls 5 and the base 6 are made in one piece and from a single material from a blank, and is thus a component produced by forming, which is not produced by further coupling or other means. The soft corner region 10 is the connecting region between the longitudinal wall 4 and the transverse wall 5, that is to say the lateral side wall with respect to the transverse direction Y of the motor vehicle or the front wall or rear wall, and therefore the transverse wall 5 with respect to the longitudinal direction X of the motor vehicle.

Furthermore, a transition 11 is formed from the respective side wall 4 or 5 to the flange 6. The transition 11 is able to have a soft material structure, analogous to the material structure of the flange 6. However, the transition 11 is also able to be hard.

The softer material structure with a tensile strength Rm of less than 1100 MPa is also able to be formed in the region of the flange 6 or in a transient corner region 12. This is then the region in which the corner region merges into the base 3. This is also shown once again with reference to the image plane of FIG. 1 at the lower right.

A respective transition 13 from base 3 to side wall, i.e., transverse wall 5 or longitudinal wall 4, has a higher tensile strength of greater than 1250 MPa. This extends in the longitudinal direction L over at least 70% of the longitudinal wall 4 shown here. The transition 13 is then formed peripherally between the base 3 and the respective side wall 4, 5 over at least 70%. Furthermore, a transition 11 is formed from the respective side wall 4 or 5 to the flange 6. The transition 11 is able to have a soft material structure, analogous to the material structure of the flange 6.

With reference to the illustration in FIG. 1, the soft material structure is not formed in the straight longitudinal or transverse section of the side wall 4 or transverse wall 5. Starting from the respective corner region in which the straight section of the side wall 4 or the transverse wall 5 begins, less than 10%, less than 5%, and less than 4%, of the length, which runs in the longitudinal or transverse direction, i.e., in the X direction or Y direction of the motor vehicle, is formed with a soft material structure. The remainder of the side wall, that is to say the predominant part of the side wall, has a hard material structure.

Furthermore, longitudinal beads 19 or transverse beads 20 are then able to be formed in the base 3. The latter then project upwards in relation to the base 3 in the vertical direction of the motor vehicle or downwards in the vertical direction of the force.

The manner in which the blank according to the present disclosure is now pretreated in order to produce the later battery tray therefrom is shown in FIG. 2A and FIG. 2B.

FIG. 2A shows a blank 14 for producing the battery tray 1. This blank 14 is able to be of rounded design in the later outer corner regions, and thus have rounded corners 15. In the corner regions 10 formed later, the blank 14 is pretempered with a temperature of 600° C. to 750° C. This, is able to be as intermediate cooling from a previously existing temperature above Ac3 temperature, for example, greater than 800° C., or greater than 900° C. The remaining region of the blank 14 has a temperature greater than 800° C., or greater than 900° C., and thus an austenitic material structure.

According to FIG. 2B, the battery tray 1 has been formed. The outer dimensions have been reduced as a result of the deep-drawing process. The later corner regions 10 in the respective transition of the transverse walls 5 to the longitudinal walls 4 are then able to be correspondingly soft. By means of a deep-drawing process, according to the principle of cup drawing, these corner regions 10 have the highest degrees of deformation. On account of the intermediate cooling temperature, a better deformation and/or a corresponding material flow from adjacent even hotter regions are able to be found here. Existing stretches are then compensated for by a softer tensile strength also on the finished battery tray 1, so that there is no delayed crack formation here. The remaining regions, which together with the transverse walls 5, longitudinal walls 4, transition 13, the base 3 and the flange 6 running around the outside have a tensile strength Rm of greater than 1250 MPa, so that a sufficient inherent rigidity is provided.

In the illustration according to FIG. 2B, the outer flange 6 is also hardened, and is therefore designed with a tensile strength Rm of greater than 1250 MPa. Furthermore, the outer corner region, shown in reference numeral 12, thus the transition 13 from the corner region 10 to the base 3, also has a softer material structure.

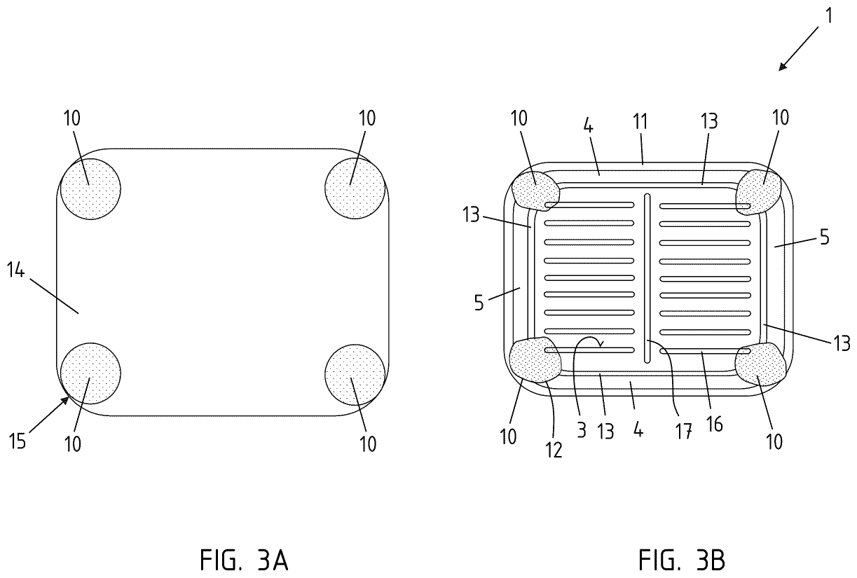

FIG. 3A and FIG. 3B show an alternative design variant. This is seen analogously to FIG. 2A and FIG. 2B, in which case the outer flange 6 is not peripherally hardened, but has a soft material structure in the corner region 10 itself.

An advantage according to the present disclosure is able to be seen here in the fact that in the event of a frontal or side crash, the entire corner region 10 is able to easily deform due to the low strength without tearing. This means that crash energy is able to be dissipated by deforming work. Also in the corner region 10, the structure or a continuous wall being retained, so that leaks are avoided even in the event of a crash.

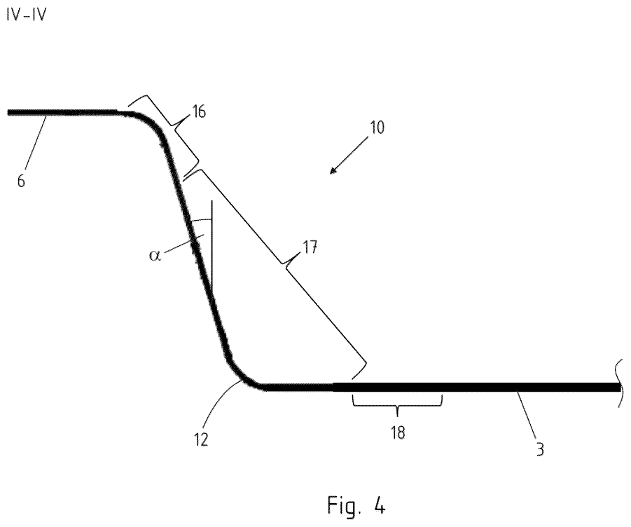

FIG. 4 shows a cross-sectional view according to the section line IV-IV of FIG. 2A and FIG. 2B. Here, a cross-sectional view through a corner region 10 is formed to recognize that the outwardly projecting flange 6, which extends in the horizontal direction, is also formed in the corner region 10. The base 3 also extends in the horizontal direction. The corner region 10 itself is arranged at an angle to the vertical and merges as an outer corner region 12 from the base 3 as a part into the respective side wall. The flange 6 itself is then able to be designed to be completely hardened or to be at least partially soft. In the region of reference numeral 16, i.e., in the transition 11 from flange 6 to the side wall section in the corner region 10, a transition zone results as a tensile strength gradient. The actual corner region 10 is then formed in the region 17 with a soft material structure. Again, a transition region 18 results in the base region, where a transition zone or tensile strength gradient is formed. Again in the base 3, the major part has not been intermediately cooled and thus has a hard material structure after the press hardening, as is shown in FIG. 4.

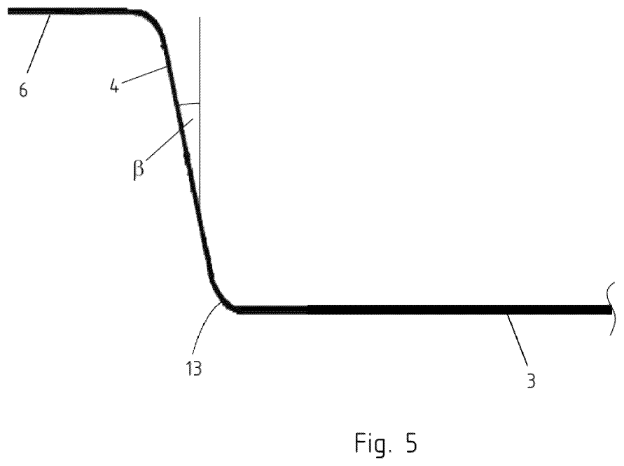

FIG. 5 shows a cross-section according to the section line V-V of FIG. 2A and FIG. 2B. This is a respective cross-sectional view through a longitudinal wall 4. The cross-sectional view is also able to take place through a transverse wall 5 and would be almost identical here. An angle β to a vertical which is formed to be <7°, <6°, ≤5°, is able to be seen in the respective longitudinal wall 4 or transverse wall 5. The smaller the angle, the better the utilization of the installation space inside the battery tray 1. However, the smaller the angle, the more difficult the deep-drawing process becomes.

The following special features are able to apply to all of the embodiments described above. The angle α in the corner region of FIG. 4, i.e., in a 45° sectional plane according to the sectional line IV-IV of FIG. 2A and FIG. 2B, is greater by at most 40%, at most 30%, and at most 25%, in relation to the angle β according to the sectional line V-V, which is shown in FIG. 5 and is, for example, on the walls 4 and 5. This means that the angle α is greater than the angle β. The relation is in accordance with the above-mentioned angular ranges, so that the angle α is at most 40% greater than the angle β. In at least one embodiment of the present disclosure, the resulting radius according to FIG. 4 in the region of reference numeral 12 is able to be at most 30%, at most 20%, and at most 15% larger than the radius for reference numeral 13 in FIG. 5. The radius is also able to be called the base radius.

Furthermore, alternatively or additionally, the radius at the transition to the flange 6 according to FIG. 4 is at most 30%, at most 20% and at most 15% larger than the transition of the radius to the flange 6 according to FIG. 5. The above-mentioned relative ratios between the angles or the respective transition radii are able to be transferred to all embodiments of the present disclosure.

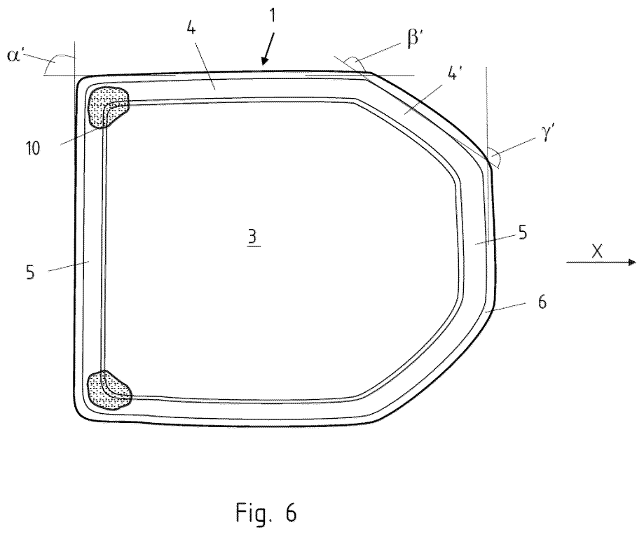

FIG. 6 shows in plan view a hexagonal battery tray. Here, two corner regions 10 are formed with an angle α′ of approximately 90°. This means that the longitudinal wall 4 extends in each case in the corner region 10 at an angle of 90° to the transverse wall 5. The longitudinal wall 4 has a further longitudinal wall 4′ in a front region. The longitudinal wall 4 and the longitudinal wall 4′ enclose an angle β′ between them. The longitudinal wall 4′ and the transverse wall 5 are then arranged at an angle γ′ of approximately 135° in a front end region, i.e., on the front transverse wall 5 on the front transverse wall 5 which is oriented in the longitudinal direction x of the motor vehicle. The angles β′ and γ′ of 135° are then completely hardened with the rest of the tray. According to the present disclosure, only the corner regions at α′ are softer with a tensile strength RM of less than 1100 MPa.

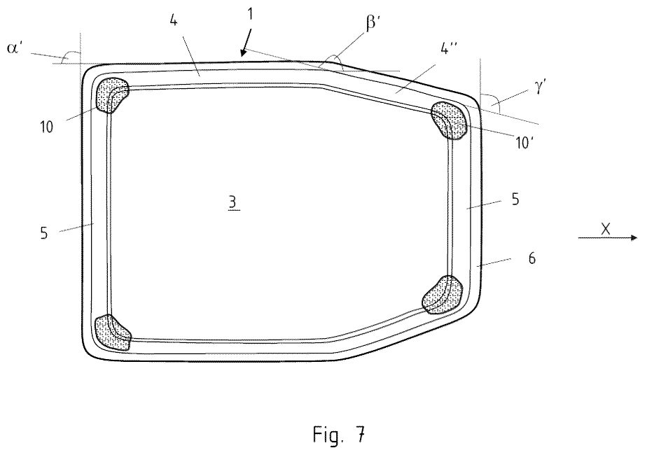

FIG. 7 shows in contrast an alternative embodiment variant. This also shows a hexagonal tray 1 in plan view. In this case, the rear corner regions 10 between the longitudinal wall 4 and the transverse wall 5, with respect to the longitudinal direction of the motor vehicle, are respectively soft. Furthermore, an angle β′ is present between a longitudinal wall 4 and a longitudinal wall 4″.

This angle β is able to be approximately 150° and is completely hardened with the remainder of the tray 1. A front corner region 10′ between the longitudinal wall 4″ and the transverse wall 5 has an angle of approximately 100°. According to the present disclosure, these corner regions are consequently also soft.

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

1-11. (canceled)

12. A battery tray for a battery support of an electric vehicle, the battery tray comprising:
a base; and
a peripheral wall extending from the base, wherein
the peripheral wall is configured in one-piece with, and of a same material as, the base,
the battery tray comprises a hot-formed and press-hardened component from a hardenable sheet steel blank, and
the battery tray has a tensile strength Rm greater than or equal to 1250 MPa, except at a corner region of the peripheral wall where the tensile strength Rm is less than 1100 MPa.

13. The battery tray according to claim 12, wherein the peripheral wall includes a plurality of side walls, and the corner region is between the base and two adjacent side walls among the plurality of side walls of the peripheral wall.

14. The battery tray according to claim 12, wherein the tensile strength Rm in the corner region is between 900 MPa and 550 MPa.

15. The battery tray according to claim 12, further comprising an outer peripheral flange which projects outwardly from an upper portion of the peripheral wall, wherein
the flange has the tensile strength Rm of greater than or equal to 1250 MPa in a region over the corner region of the peripheral wall.

16. The battery tray according to claim 12, wherein the corner region comprises a mixed structure of bainite, ferrite, and perlite.

17. The battery tray according to claim 12, further comprising a transition from the base to the peripheral wall, wherein
the peripheral wall includes a plurality of side walls,
the transition has the tensile strength Rm greater than 1250 MPa, and
the transition extends over at least 70% of a length of a side wall among the plurality of side walls of the peripheral wall, and is configured as a deep-drawing radius.

18. The battery tray according to claim 15, further comprising a side reinforcement coupled to an exterior of at least one of the peripheral wall or the flange.

19. The battery tray according to claim 12, further comprising a first corrosion protection layer comprising AlSi.

20. The battery tray according to claim 12, wherein
the peripheral wall comprises side walls of different heights, and
the battery tray further comprises a matching cover or hood, which comprises a further tray and which is complementary to the different heights of the side walls of the peripheral wall.

21. The battery tray according to claim 12, further comprising longitudinal or transverse beads in the base.

22. A method of producing a battery tray according to claim 12, the method comprising:
partial austenitizing or complete austenitizing of the sheet steel blank, and partial intermediate cooling of the corner region; and
inserting the sheet steel blank into a hot forming and press hardening tool, and performing hot forming and press hardening of the blank to obtain the battery tray, wherein the tensile strength Rm of greater than or equal to 1250 MPa is set in the battery tray, except at the corner region where the tensile strength Rm of less than 1100 MPa is set.

23. The battery tray according to claim 12, further comprising an outer peripheral flange which projects outwardly from an upper portion of the peripheral wall.

24. The battery tray according to claim 12, wherein the tensile strength Rm in the corner region is between 600 MPa and 800 MPa.

25. The battery tray according to claim 15, wherein the flange is completely hardened all around.

26. The battery tray according to claim 12, wherein the corner region comprises a mixed structure of bainite, ferrite, perlite, and martensite.

27. The battery tray according to claim 18, wherein the side reinforcement comprises a sheet metal component or a hollow profile.

28. The battery tray according to claim 19, further comprising a second corrosion protection layer on the first corrosion protection layer, and the second corrosion protection layer comprising a cathodic dip coating or powder coating layer.
